(19) United States
(12) Patent Application Publication
(10) Pub. No.: US 2024/0324649 A1
(43) Pub. Date: Oct. 3, 2024

(54) MULTI-FREQUENCY ULTRASOUND COUPLED MULTI-NOZZLE FOOD ADDITIVE MANUFACTURING DEVICE AND METHOD

(71) Applicant: JIANGSU UNIVERSITY, Zhenjiang (CN)

(72) Inventors: Baoguo XU, Zhenjiang (CN); Min FENG, Zhenjiang (CN); Lin LIN, Zhenjiang (CN); Jingfu PAN, Zhenjiang (CN); Xiaofeng REN, Zhenjiang (CN); Cunshan ZHOU, Zhenjiang (CN); Haile MA, Zhenjiang (CN)

(73) Assignee: JIANGSU UNIVERSITY, Zhenjiang (CN)

(21) Appl. No.: 18/570,079

(22) PCT Filed: Jun. 28, 2023
(86) PCT No.: PCT/CN2023/103099

§ 371 Date: Dec. 14, 2023

(30) Foreign Application Priority Data
Aug. 8, 2022 (CN) 202210947855.X

(51) Int. Cl. A23P 30/20; B33Y 10/00; B33Y 30/00; B33Y 50/02

(52) U.S. Cl. CPC A23P 30/20; B33Y 10/00; B33Y 30/00; B33Y 50/02

(57) ABSTRACT

A multi-frequency ultrasound coupled multi-nozzle food additive manufacturing device and method are provided. A multi-frequency ultrasound coupling printing system is set up on a multi-nozzle additive manufacturing device, which improves the rheological properties of high-viscosity and large-particle food ink by generating a cavitation effect through the high-frequency vibration of ultrasound and improves the printability of food ink while retaining the nutrients and texture of the food ink. The application of the multi-frequency ultrasound coupled multi-nozzle device to food additive manufacturing enables it to achieve a smaller nozzle diameter and higher printing speed than conventional additive manufacturing systems, which improves the printability of the food ink while realizing large-scale production. The multi-frequency ultrasound coupled multi-nozzle food additive manufacturing device and method can also improve the digestive and functional properties of foodstuffs by utilizing multi-frequency ultrasound, and enhance the sensory and nutritional qualities of the printed products.

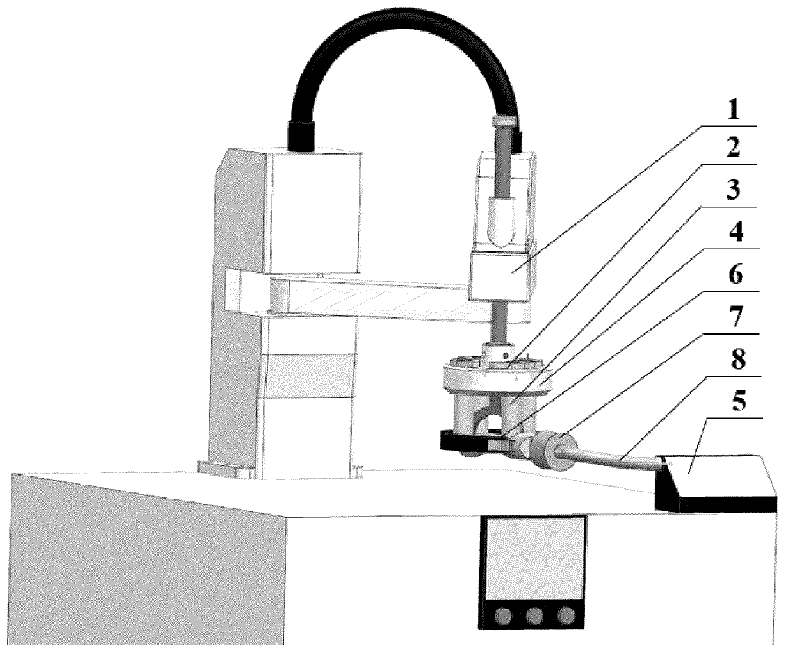

This application is the national phase entry of International Application No. PCT/CN2023/103099, filed on Jun. 28, 2023, which is based upon and claims priority to Chinese Patent Application No. 202210947855.X, filed on Aug. 8, 2022, the entire contents of which are incorporated herein by reference.

### TECHNICAL FIELD

The present disclosure relates to a multi-frequency ultrasound coupled multi-nozzle food additive manufacturing device and method, which belongs to the technical field of food additive manufacturing.

### BACKGROUND

Food additive manufacturing technology, as an emerging digital manufacturing, has the advantage of personalization of nutrition, shape, and texture, which is well suited to meet individual consumer requirements. While food paste can be used for food additive manufacturing, it typically relies on material modification for extrusion. This food material modification is achieved through the use of diluents at the expense of nutrient content and texture, resulting in printed products that lag behind the typical characteristics of conventionally manufactured foods.

Multi-frequency ultrasound-assisted printing, which is an improved additive manufacturing method, is capable of printing high-viscosity materials similar to common food products.

In order to solve the problem that the food ink containing large particles and coarse fibers is difficult to extrude and the degree of printing gelation is low in the printing process, there is now publicly available additive manufacturing equipment (CN 113974194 A) which disclosed that the ultrasound assisted system is set up on the basis of microwave 3D printing equipment. It can achieve the synchronization of physical field action and the extrusion process, so as to obtain a better additive manufacturing effect to a certain extent.

However, the above method only uses a specific type of ultrasonic wave with a specific frequency to generate a localized physical field area, and the scope of application is narrow. The multi-frequency ultrasonic system can realize multi-frequency selection, pulsed ultrasonic generation, and intelligent feedback adjustment of extrusion pressure, thereby improving the printability of the ink. In addition, the above approach is mainly for single-nozzle printing, and does not mention large-scale commercialized multi-nozzle printing technology. The present application provides a multi-frequency ultrasound-coupled multi-nozzle food additive manufacturing device and method, which not only improves the printability and printing speed of the printing process of food ink, but also realizes large-scale production.

### SUMMARY

Aiming at the insufficient processing efficiency of food additive manufacturing processing equipment, as well as the problems of poor printability of high-viscosity and large-particle food inks and severely limited production scale, the present disclosure provides a multi-frequency ultrasound coupled multi-nozzle food additive manufacturing device and method, which enhances the printability of high-viscosity food printing inks and realizes the large-scale production. It is specifically in accordance with the following steps:
A multi-frequency ultrasound coupled multi-nozzle food additive manufacturing device includes a control module, a multi-nozzle device, and a multi-frequency ultrasound strengthening device; where
the control module includes an extrusion pressure control system and a multi-frequency ultrasound control system;
the multi-nozzle device includes an extrusion pressure supply unit, an integrated barrel, and a multi-nozzle extrusion unit;
the integrated barrel consists of multiple barrels arranged in a “rake” or “revolver” shape.

Each equipped with an extrusion nozzle, enabling food additive manufacturing at scale;
the integrated barrel can simultaneously print from 2 to 6 barrels at the same time;
the multi-frequency ultrasound device includes a multi-frequency ultrasonic generator, an ultrasonic transducer, an ultrasonic horn, and an ultrasonic transmission line; the ultrasonic transducer is connected with one end of the ultrasonic horn; the ultrasonic horn is connected to an outer wall of the integrated barrel;
according to a number of the barrels, an end of ultrasonic horn is designed to rings in a circular shape, each of the rings is around the outer wall of the integrated barrel; an inner diameter of the rings matches an outer diameter of the integrated barrel and they are closely linked to make a print ink uniformly receive ultrasonic energy;
optionally, the ultrasonic horn is set in an upper, middle or lower position of the outer wall of the barrel according to a particle size and a viscosity of a food ink; and
the ultrasonic generator has a plurality of different frequencies (20 to 100 kHz), and a specific working mode is selected according to the particle size and the viscosity of the food ink; the ultrasonic transducer transmits the ultrasonic energy to the food ink inside the integrated barrel, triggering vibration of particles inside the food ink, thereby generating cavitation, thermal and mechanical effects.

The present application also provides a multi-frequency ultrasound coupled multi-nozzle food additive manufacturing method, including:
according to printing requirements, selecting an ultrasonic frequency and a position of the ultrasonic horn, wherein the ultrasonic horn is set in the upper, middle or lower position of the outer wall of the barrel; and
importing printed information into the control module and setting output parameters of an ultrasound; where
optionally, when the food ink is large particles, coarse fibers or a high-viscosity slurry, a corresponding high amplitude ultrasound is selected, and the ultrasonic horn is placed in the upper position of the integrated barrel; and
when the food ink has conventional particle size, a corresponding low amplitude ultrasound is selected and the ultrasonic horn is placed in the lower position of the integrated barrel.

### Beneficial Effects of the Present Disclosure:

(1) A multi-frequency ultrasonic strengthening system is set up on the basis of traditional additive manufacturing device. The multi-frequency ultrasonic device can realize selections of different frequencies, pulsed ultrasonic generation, and intelligent feedback adjustment of the extrusion pressure, which realizes the direct printing of high-viscosity non-Newtonian fluid printing ink, enhances the printability and preserves the nutrient composition and texture of the printing ink.
(2) The multi-nozzle device can realize 2-6 nozzles working at the same time, overcoming time-consuming and low-capacity problems of the traditional additive manufacturing, ensuring the printability and promoting large-scale production.

### BRIEF DESCRIPTION OF THE DRAWINGS

In order to more clearly illustrate the technical solutions in the embodiments of the present disclosure, the accompanying drawings to be used in the description of the embodiments will be briefly described below.

The FIGURE shows a diagram of the multi-frequency ultrasound coupled multi-nozzle food additive manufacturing device.
where, 1-control device, 2-extrusion pressure supply device, 3-integrated barrel, 4-multi-nozzle extrusion device, 5-ultrasonic generator, 6-ultrasonic horn, 7-ultrasonic transducer, 8-ultrasonic transmission line

### DETAILED DESCRIPTION OF THE EMBODIMENTS

Considering the requirements of the actual production process in terms of high-volume and large-scale manufacturing, a multi-nozzle in simultaneous working mode is applied to food additive manufacturing to improve production efficiency.

### Embodiment 1

This embodiment provides a multi-frequency ultrasound coupled multi-nozzle food additive manufacturing device, which is comprising of a control module, a multi-nozzle device and a multi-frequency ultrasound device.

The multi-nozzle device includes a control device 1, an extrusion pressure supply unit 2, an integrated barrel 3, and a multi-nozzle extrusion unit 4.

The control device 1 can be moved to adjust different printing positions in the X, Y and Z-axis directions, respectively, according to the printing effect.

The control device 1 is connected to a plurality of integrated barrels 3, each of which is equipped with an extrusion nozzle 4, enabling large-scale production.

The integrated barrel 3 can simultaneously print from two to six barrels at the same time.

The multi-frequency ultrasound device includes a multi-frequency ultrasonic generator 5, an ultrasonic horn 6, an ultrasonic transducer 7, and an ultrasonic transmission line 8.

The ultrasonic transducer 7 is connected with one end of the ultrasonic horn 6. The ultrasonic horn 6 is connected with the outer wall of the integrated barrel 3.
According to the number of barrels, the end of ultrasonic horn 6 was designed to rings (circular shape), each ring is around the outer wall of the barrel 3. The inner diameter of the ring matches the outer diameter of the barrel 3 and they are closely linked to make the print ink uniformly receive ultrasonic wave.

Specifically, the ultrasonic horn 6 is set in the upper, middle and lower positions of the outer wall of the barrel 3 according to the size of the particles and the viscosity of the material.

As shown in the FIGURE, the ultrasonic horn 6 is set in the middle of the integrated barrel 3. In this mode, ultrasonic vibration energy can be transmitted to the printing ink, thus triggering vibration of the particles and generating cavitation, thermal and mechanical effect.

The ultrasonic generator 5 has a plurality of different frequencies (20 to 100 kHz), which can select a specific working mode according to the particle size and the viscosity of the ink.

The ultrasonic generator 5 is connected to the transducer 7 through the ultrasonic transmission line 8, and the ultrasonic power, frequency, time and ultrasonic pulse ratio and other parameters are regulated through the generator, and the ultrasonic intensity can be appropriately reduced when it is treated as used for sensitive materials.

### Embodiment 2

The present embodiment provides a multi-frequency ultrasound coupled multi-nozzle food additive manufacturing method.

The printed information is imported into the control module and set the extrusion pressure and output parameters of the ultrasound.

Optionally, when the printing ink is large particles, coarse fibers and high viscosity, the corresponding high amplitude ultrasound is selected as well as the ultrasonic horn is placed in the upper position of the integrated barrel. When the printing ink is conventional particle size, the appropriate low amplitude ultrasound is selected and the ultrasonic horn is placed in the lower position of the integrated barrel.

The electrical signal generated by the ultrasonic source passes through the ultrasonic transmission line 8 to the ultrasonic transducer 7, and then the ultrasonic wave is generated. The ultrasonic wave is applied to the integrated barrel 3 through the ultrasonic horn 6, and the cavitation effect and mechanical effect generated by ultrasonic vibration are applied to treat the printing ink.

During the printing process, the ultrasound modes include different ultrasonic frequencies (20 to 100 kHz), different ultrasonic powers (0 to 300 W), and different pulse intervals (5 s/5 s, 10 s/5 s, 10 s/0 s). The positions of the ultrasonic horn 6 include the upper, middle, and lower positions of the integrated barrel 3.

The ultrasonic horn 6 with high amplitude ultrasound is located in the upper part of the integrated barrel 3, which is suitable for food ink containing large particles and coarse fiber for breaking up tissues, reducing the viscosity and facilitating the extrusion. In addition, the release of aromatic and nutrient substances is facilitated, improving the organoleptic and nutritional properties of the printed product.

The ultrasonic horn 6 with low amplitude ultrasound is located in the lower part of the integrated barrel 3 and is suitable for printing conventional particle-size inks. Such inks have a suitable viscosity and gelation capacity, which is affected by using ultrasonic vibrations to create sliding conditions at the nozzle boundaries, thus enabling selective sinking of positively viscous materials.

What is claimed is:

1. A multi-frequency ultrasound coupled multi-nozzle food additive manufacturing device, comprising a control module, a multi-nozzle device, and a multi-frequency ultrasound strengthening device, wherein
the control module comprises an extrusion pressure control system and a multi-frequency ultrasound control system;
the multi-nozzle device comprises an extrusion pressure supply unit, an integrated barrel, and a multi-nozzle extrusion unit;
the integrated barrel consists of multiple barrels arranged in a “rake” or “revolver” shape, each equipped with an extrusion nozzle, enabling food additive manufacturing at scale;
the integrated barrel simultaneously prints from 2 to 6 barrels at the same time;
the multi-frequency ultrasound strengthening device comprises a multi-frequency ultrasonic generator, an ultrasonic transducer, an ultrasonic horn, and an ultrasonic transmission line;
the ultrasonic transducer is connected with one end of the ultrasonic horn; the ultrasonic horn is connected to an outer wall of the integrated barrel;
according to a number of the barrels, an end of the ultrasonic horn is designed as rings in a circular shape, each of the rings is around the outer wall of the integrated barrel; an inner diameter of the rings matches an outer diameter of the integrated barrel and they are closely linked to make a print ink uniformly receive ultrasonic energy;
the ultrasonic horn is set in an upper, middle or lower position of the outer wall of the barrel according to a particle size and a viscosity of a food ink;
the ultrasonic generator has a plurality of different frequencies from 20 to 100 kHz, and a specific working mode is selected according to the particle size and the viscosity of the food ink; and
the ultrasonic transducer transmits the ultrasonic energy to the food ink inside the integrated barrel, triggering vibration of particles inside the food ink, thereby generating cavitation, thermal and mechanical effects.

2. A multi-frequency ultrasound coupled multi-nozzle food additive manufacturing method according to claim 1, comprising:
according to printing requirements, selecting an ultrasonic frequency and a position of the ultrasonic horn, wherein the ultrasonic horn is set in the upper, middle or lower position of the outer wall of the barrel; and
importing printed information into the control module and setting output parameters of an ultrasound; wherein
optionally, when the food ink is large particles, coarse fibers or a high-viscosity slurry, a corresponding high amplitude ultrasound is selected, and the ultrasonic horn is placed in the upper position of the integrated barrel; and
when the food ink has a conventional particle size, a corresponding low amplitude ultrasound is selected and the ultrasonic horn is placed in the lower position of the integrated barrel.
